(19) United States
(12) Patent Application Publication
(10) Pub. No.: US 2020/0074315 A1
(43) Pub. Date: Mar. 5, 2020

(54) GENERATING DIVERSE PLANS

(71) Applicant: International Business Machines Corporation, Armonk, NY (US)

(72) Inventors: Michael Katz, Elmsford, NY (US); Shirin Sohrabi Araghi, Briarcliff manor, NY (US)

(21) Appl. No.: 16/121,281

(22) Filed: Sep. 4, 2018

(51) Int. Cl. G06N 5/02; G06F 21/56

(52) U.S. Cl. CPC G06N 5/022; G06F 21/56

(57) ABSTRACT

Techniques regarding autonomous generation of one or more sets of diverse plans are provided. For example, one or more embodiments described herein can comprise a system, which can comprise a memory that can store computer executable components. The system can also comprise a processor, operably coupled to the memory, and that can execute the computer executable components stored in the memory. The computer executable components can comprise a planner component, operably coupled to the processor, that can generate a first plan based on a planning task. The computer executable components can also comprise a modification component, operably coupled to the processor, that can generate a modification to the planning task to facilitate generation of a second plan by the planner component. The second plan can be a variant of the first plan.

### BACKGROUND

The subject disclosure relates to generating diverse plans, and more specifically, to one or more computer systems and/or methods that can facilitate autonomous generation of one or more sets of diverse plans.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, apparatuses and/or computer program products that can facilitate autonomous generation of one or more sets of diverse plans are described.

According to an embodiment, a system is provided. The system can comprise a memory that stores computer executable components. The system can also comprise a processor, operably coupled to the memory, and that can execute the computer executable components stored in the memory. The computer executable components comprise a planner component, operably coupled to the processor, that can generate a first plan based on a planning task. The computer executable components can also comprise a modification component, operably coupled to the processor, that can generate a modification to the planning task to facilitate generation of a second plan by the planner component. The second plan can be a variant of the first plan.

According to an embodiment, a computer-implemented method is provided. The computer-implemented method can comprise generating, by a system operatively coupled to a processor, a first plan by an artificial intelligence planner based on a planning task. The computer-implemented method can also comprise generating, by the system, a modification to the planning task to facilitate generation of a second plan by the artificial intelligence planner. The second plan can be a variant of the first plan.

According to an embodiment, a computer program product for generating a set of diverse plans is provided. The computer program product can comprise a computer readable storage medium having program instructions embodied therewith. The program instructions can be executable by a processor to cause the processor to generate, by a system operatively coupled to the processor, a first plan by an artificial intelligence planner based on a planning task. The program instructions can also cause the processor to generate, by the system, a modification to the planning task to facilitate generation of a second plan by the artificial intelligence planner. The second plan can be a variant of the first plan.

### BRIEF DESCRIPTION OF THE DRAWINGS

FIG. 1 illustrates a block diagram of an example, non-limiting system that can autonomously generate one or more sets of diverse plans in accordance with one or more embodiments described herein.

FIG. 2 illustrates a diagram of an example, non-limiting reformulation algorithm that can be utilized by one or more systems to autonomously generate one or more sets of diverse plans in accordance with one or more embodiments described herein.

FIG. 3 illustrates another block diagram of an example, non-limiting system that can autonomously generate one or more sets of diverse plans in accordance with one or more embodiments described herein.

FIG. 4 illustrates a diagram of an example, non-limiting table that can depict the efficacy of one or more systems, which can autonomously generate one or more sets of diverse plans, in accordance with one or more embodiments described herein.

FIG. 5 illustrates a diagram of an example, non-limiting graph that can depict the efficacy of one or more systems, which can autonomously generate one or more sets of diverse plans, in accordance with one or more embodiments described herein.

FIG. 6 illustrates a flow diagram of an example, non-limiting method that can facilitate autonomously generating one or more sets of diverse plans in accordance with one or more embodiments described herein.

FIG. 7 illustrates a flow diagram of an example, non-limiting method that can facilitate autonomously generating one or more sets of diverse plans in accordance with one or more embodiments described herein.

FIG. 8 depicts a cloud computing environment in accordance with one or more embodiments described herein.

FIG. 9 depicts abstraction model layers in accordance with one or more embodiments described herein

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Many planning applications (e.g., malware detection, automated analysis of streaming data, risk management, and/or the like) require the generation of multiple plans. Additionally, planners that produce multiple plans can be useful in the context of re-planning and plan monitoring, user preferences, and/or as the engine for plan recognition. Thus, a plurality of applications can require the acquisition of a diverse set of plans.

Conventional diverse planners focus on addressing a particular diversity metric (e.g., a landmark-based diversity metric and/or a minimum action distance metric), and/or evaluate different diversity metrics using several planners, which can additionally consider plan quality. For example, some conventional diversity planners can find a diverse set of plans from a collection of cost sensitive plans. However, the use of several planners to facilitate generation of a set of diverse plans can render comparisons of the plans and/or planners challenging. Further, mixing quality and diversity metrics can create an additional challenge for comparing various planners (e.g., especially if the planners have different optimality guarantees). Additionally, many conventional diverse planning approaches can compute the set of plans by repeatedly solving the same planning task and modifying the planner's heuristic guidance towards the plans during planning with a specific focus on a particular metric. Therefore, conventional diverse planning approaches require a user and/or system: to be intimately familiar with the way a particular planner works, and/or create a separate modification for each subject metric. These requirements can lead to unexpected and/or undesirable outcomes. For example, modifying the heuristic function does not necessarily result in a different plan from the previous iteration, and thus the planners often discard many equal plans and repeat unnecessary iterations.

Various embodiments of the present invention can be directed to computer processing systems, computer-implemented methods, apparatus and/or computer program products that facilitate the efficient, effective, and autonomous (e.g., without direct human guidance) generation of one or more sets of diverse plans. For example, one or more embodiments can regard one or more diverse planning approaches that can comprise modifying one or more planning tasks, and thereby generate one or more variants of a planning task using a common planner to achieve one or more sets of diverse plans. Additionally, various embodiments can comprise post-processing the one or more sets of diverse plans to derive one or more subsets of diverse plans of a desired size in accordance with a user preference. Advantageously, the one or more diverse planning approaches facilitated by the systems and/or methods described herein can be applicable to various pre-existing planners and can exploit recent advances in classical planning.

The computer processing systems, computer-implemented methods, apparatus and/or computer program products employ hardware and/or software to solve problems that are highly technical in nature (e.g., generating a variety of diverse plans to address one or more planning problems), that are not abstract and cannot be performed as a set of mental acts by a human. For example, an individual, or even a plurality of individuals, cannot readily collect, maintain, and/or analyze vast volumes of data as expeditiously and/or efficiently as the various embodiments described herein. Additionally, one or more embodiments described herein can utilize artificial intelligence (“AI”) technologies that are autonomous in their nature to facilitate determinations and/or predictions that cannot be readily performed by a human.

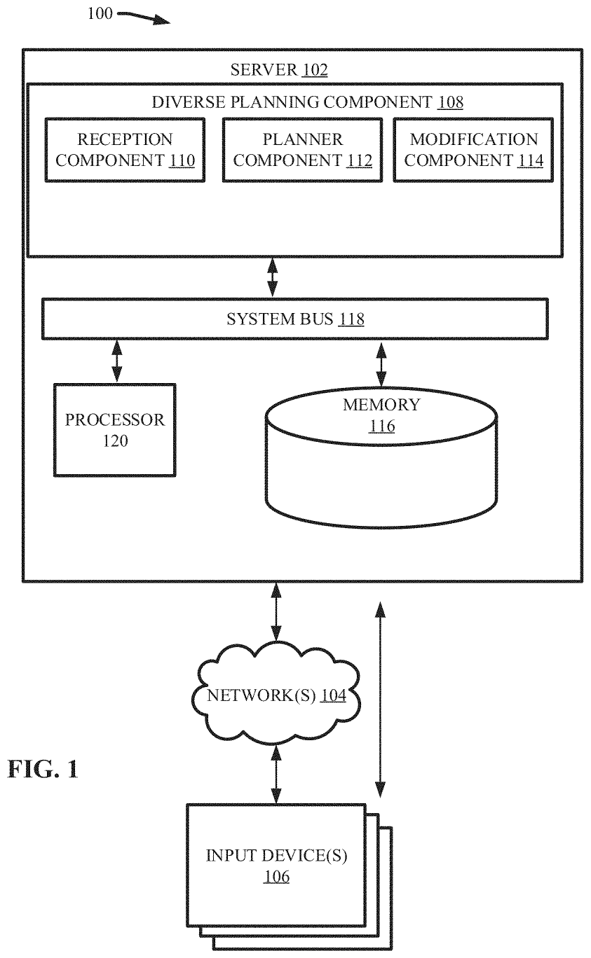

FIG. 1 illustrates a block diagram of an example, non-limiting system 100 that can autonomously generate one or more sets of diverse plans in accordance with one or more embodiments described herein. Repetitive description of like elements employed in other embodiments described herein is omitted for sake of brevity. Aspects of systems (e.g., system 100 and the like), apparatuses or processes in various embodiments of the present invention can constitute one or more machine-executable components embodied within one or more machines, e.g., embodied in one or more computer readable mediums (or media) associated with one or more machines. Such components, when executed by the one or more machines, (e.g., computers, computing devices, virtual machines, etc.) can cause the machines to perform the operations described.

As shown in FIG. 1, the system 100 can comprise one or more servers 102, one or more networks 304, and/or one or more input devices 106. The server 102 can comprise diverse planning component 108. The diverse planning component 108 can further comprise reception component 110, planner component 112, and/or modification component 114. Also, the server 102 can comprise or otherwise be associated with at least one memory 116. The server 102 can further comprise a system bus 118 that can couple to various components such as, but not limited to, the diverse planning component 108 and associated components, memory 116 and/or a processor 120. While a server 102 is illustrated in FIG. 1, in other embodiments, multiple devices of various types can be associated with or comprise the features shown in FIG. 1. Further, the server 102 can communicate with the one or more cloud computing environments (e.g., via the one or more networks 104).

The one or more networks 104 can comprise wired and/or wireless networks, including, but not limited to, a cellular network, a wide area network (WAN) (e.g., the Internet) or a local area network (LAN). For example, the server 102 can communicate with the one or more input devices 106 (and vice versa) using virtually any desired wired or wireless technology including for example, but not limited to: cellular, WAN, wireless fidelity (Wi-Fi), Wi-Max, WLAN, Bluetooth technology, a combination thereof, and/or the like. Further, although in the embodiment shown the diverse planning component 108 can be provided on the one or more servers 102, it should be appreciated that the architecture of system 100 is not so limited. For example, the diverse planning component 108, or one or more components of diverse planning component 108, can be located at another computer device, such as another server device, a client device, etc.

The one or more input devices 106 can comprise one or more computerized devices, which can include, but are not limited to: personal computers, desktop computers, laptop computers, cellular telephones (e.g., smart phones), computerized tablets (e.g., comprising a processor), smart watches, keyboards, touch screens, mice, a combination thereof, and/or the like. A user of the system 100 can utilize the one or more input devices 106 to input data into the system 100, thereby sharing (e.g., via a direct connection and/or via the one or more networks 104) said data with the server 102. For example, the one or more input devices 106 can send data to the reception component 110 (e.g., via a direct connection and/or via the one or more networks 104). Additionally, the one or more input devices 106 can comprise one or more displays that can present one or more outputs generated by the system 100 to a user. For example, the one or more displays can include, but are not limited to: cathode tube display (“CRT”), light-emitting diode display (“LED”), electroluminescent display (“ELD”), plasma display panel (“PDP”), liquid crystal display (“LCD”), organic light-emitting diode display (“OLED”), a combination thereof, and/or the like. In one or more embodiments, a user of the system 100 can utilize the one or more input devices 106 to provide the diverse planning component 108: one or more planning problems, one or more planning task inputs, one or more preferences regarding desired planners to utilize, and/or one or more integer values that can define the size of a set of diverse plans (e.g., the number of diverse plans that can be comprised within the set of diverse plans) or the size of a subset of diverse plans (e.g., the number of diverse plans that can be comprised within the subset), a combination thereof, a plan quality metric, a plan diversity metric, and/or the like.

The reception component 110 can be operably coupled to the one or more input devices 106 directly or indirectly (e.g., via the one or more networks 104) and can receive the one or more inputs for analyzation by one or more components of the diverse planning component 108. For example, the reception component 110 can be operably coupled to the planner component 112 and can facilitate transference of the one or more inputs to the planner component 112 to facilitate generation of an initial plan.

In one or more embodiments, the planner component 112 can comprise one or more AI planner algorithms utilized to generate a plan based on a planning task. The diverse planning component 108 can select an AI planner algorithm to serve as the planner component 112 based on a preference of the user and/or a default setting of the system 100. Example AI planner algorithms that can comprise the planner component 112 can include, but are not limited to: fs-blind, fs-sim, DecStar, Symple-1, Symple-2, freelunch-madagascar, freelunch-doubly-relaxed, mercury2014, saarplan, OLCFF, MERWIN, Cerberus, Cerberus-gl, IBaCoP-2018, IBaCoP2-2018, LAPKT-DUAL-BFWS, LAPKT-POLYNOMIAL-BFWS, LAPKT-DFS+, LAPKT-BFWS-Preference, alien, Fast Downward Remix, Fast Downward Stone Soup 2018, a combination thereof, and/or the like.

For example, the planning task utilized by the planner component 112 can be defined, for example, by a tuple “<V, A, s₀, s*>”, wherein one or more of the variables can be inputted into the system 100 by a user via the one or more input devices 106. In the example planning task tuple, “V” can represent a set of state variables, “A” can represent a finite set of actions, “s₀” can represent an initial state, and “s*” can represent a goal state. Respective state variables can be assigned to a respective state, and actions can delineate how one state transitions to another. Thus, actions and variables can implicitly encode a transition system, which can be represented as a graph of states represented by nodes and actions represented by edges. The initial state can be a first state, and the goal state can be a state that agrees with a partial assignment of one or more of the state variables. The planning task can identify a sequence of actions that when applied to an initial state will result in a goal state. Therefore, the planner component 112 can generate one or more plans (e.g., comprising a sequence of actions) based on the planning task to solve one or more planning problems.

In various embodiments, the planner component 112 can be utilized by the diverse planning component 108 to solve one or more diverse planning problems, which can necessitate generation of a set of multiple plans that are diverse, as compared to each other, with regards to a subject diversity metric. For example, a set of diverse plans can comprise a plurality of plans generated by the planner component 112, wherein each respective plan in the set can be a distinct variant of each other. For instance, each plan comprised within a set of diverse plans can be different than the other plans comprised within the set. Thus, a set of diverse plans can be void of duplicate plans and can achieve diversity via variations between plans.

The diverse planning component 108 can generate a plurality of plans to achieve a diverse planning solution. For example, wherein “Π” can represent a planning task and “ [symbol] ” can represent a set of all the plans that can be achieved by the planning task; given a natural number “k” (e.g., an integer that can be defined by a user of the system 100 using the one or more input devices 106 and/or the one or more networks 104), “P⊆ [symbol] ” can be a diverse planning solution if |P|=k or P= [symbol] if |P|<k.

In one or more embodiments, the planner component 112 can generate a plurality of plans to achieve a diverse planning solution for a satisficing diverse planning problem. For example, a satisficing diverse planning problem can be a diverse planning solution in which the planner component 112 does not impose restrictions on quality and/or diversity of the plans comprising the set of diverse plans. For instance, a satisficing diverse planning problem can be defined as: given an integer value “k” (e.g., which can delineate a size of the set of diverse plans and/or a size of a subset of the set), find a diverse planning solution. The objective of the satisficing diverse planning solution can be to find any set of “k” plans without restrictions on either quality or diversity.

In one or more embodiments, the planner component 112 can generate a plurality of plans to achieve a diverse planning solution for a bounded quality diverse planning problem or a bounded diversity diverse planning problem. For example, a bounded quality diverse planning problem or a bounded quality diverse planning problem can be the set of feasible solutions by applying one or more restrictions on quality or diversity of the subject plans comprising the set.

For instance, wherein “Π” can represent a planning task, “D” can represent a diversity metric, “b” can represent a bound, and/or “ [symbol] ” can represent a set of all plans that can be achieved by the planning task; given a natural number “k” (e.g., an integer that can be defined by a user of the system 100 using the one or more input devices 106 and/or the one or more networks 104), P⊆ [symbol] can be a diversity-bounded diverse planning solution if it is a diverse planning solution and D(P)≥b. Thus, a diversity bounded diverse planning problem can be defined as: given an integer value “k” (e.g., which can delineate a size of the set of diverse plans and/or a size of a subset of the set) and a diversity metric “b”, find a diversity-bounded diverse planning solution.

In another instance, wherein “Π” can represent a planning task, “Q” can represent a quality metric, “c” can represent a bound, and/or “ [symbol] ” can represent a set of all plans that can be achieved by the planning task; given a natural number “k” (e.g., an integer that can be defined by a user of the system 100 using the one or more input devices 106 and/or the one or more networks 104), P⊆ [symbol] can be a quality-bounded diverse planning solution if it is a diverse planning solution and Q(P)≤c. Thus, a quality bounded diverse planning problem can be defined as: given an integer value “k” (e.g., which can delineate a size of the set of diverse plans and/or a size of a subset of the set) and a quality metric “c”, find a quality-bounded diverse planning solution.

Additionally, one or more embodiments, the planner component 112 can generate a plurality of plans to achieve a diverse planning solution for a bounded quality and diversity diverse planning problem. For instance, a quality and diversity bounded diverse planning problem can be defined as: given an integer value “k” (e.g., which can delineate a size of the set of diverse plans and/or a size of a subset of the set), a diversity metric “b”, and a quality metric “c”, find a quality-bounded and diversity-bounded diverse planning solution.

In one or more embodiments, the planner component 112 can generate a plurality of plans to achieve a diverse planning solution for an optimal quality diverse planning problem or an optimal diversity diverse planning problem. For instance, an optimal quality diverse planning problem can be defined as: given an integer value “k” (e.g., which can delineate a size of the set of diverse plans and/or a size of a subset of the set), find a quality-optimal diverse planning solution. For example, the planner component 112 can be a top-k planner and solve a quality diverse planning problem by optimizing the quality metric “Q=Σ_{π∈P}C(π).” In another instance, an optimal diversity diverse planning problem can be defined as: given an integer value “k” (e.g., which can delineate a size of the set of diverse plans and/or a size of a subset of the set), find a diversity-optimal diverse planning solution.

Additionally, in one or more embodiments, the planner component 112 can generate a plurality of plans to achieve a diverse planning solution for an optimal quality bounded diversity diverse planning problem or an optimal diversity bounded quality diverse planning problem. For instance, an optimal quality bounded diversity diverse planning problem can be defined as: given an integer value “k” (e.g., which can delineate a size of the set of diverse plans and/or a size of a subset of the set) and a diversity metric “b”, find a quality-optimal diverse planning solution among diversity-bounded diverse planning solutions. In another instance, an optimal diversity bounded quality diverse planning problem can be defined as: given an integer value “k” (e.g., which can delineate a size of the set of diverse plans and/or a size of a subset of the set) and a quality metric “c”, find a diversity-optimal diverse planning solution among quality-bounded diverse planning solutions.

Moreover, the planner component 112 can further restrict a set of feasible solutions to a quality-optimal diverse planning solution or a diversity-optimal diverse planning solution and choose the best according to the diversity metric or quality metric among those. Additionally, the planner component 112 can solve one or more optimization problems via optimal diverse planning, which can comprise finding a solution that is pareto-optimal (e.g., optimal solutions can be solutions on the pareto frontier of quality and diversity).

One of ordinary skill in the art will recognize that a solution to one planning problem can be necessarily a solution for another planning problem (e.g., assuming a solution exists). For example, a pareto-optimal solution can be a planning solution to either an optimal diversity diverse planning problem or an optimal quality diverse planning problem, but not necessarily to either an optimal quality bounded diversity diverse planning problem or an optimal diversity bounded quality diverse planning problem, since the latter two can optimize over the solutions that are of bounded quality and diversity, respectively. Also, planning solutions to all problems described herein can be solutions to a satisficing diversity planning problem.

In addition, one or more diversity metrics that can be utilized by the planner component 112 in various embodiments described herein can include, but are not limited to: stability metrics, state metrics, and/or uniqueness metrics. Also, the planner component 112 can consider a linear combination of one or more diversity metrics. For example, the planner component 112 can consider linear combinations with 0/1 weights of the three diversity metrics: stability, state, and/or uniqueness.

An example quality metric that can be considered by the planner component 112 in various embodiments described herein can be the summed cost of plans, which can be defined as ““Q=Σ_{π∈P}C(π).” Wherein “C” can represent cost, and “π” can represent a plan. To normalize the exemplary quality metric's value, the planner component 112 can provide the best known solution value by the value of the given AI planner algorithm. However, a single plan's quality can have a large affect on the overall quality of the set of diverse plans. For example, the quality of a set of diverse plans comprising respective plans that are optimal except for one (e.g., of high cost) can get a quality worse than a set comprising entirely comprising respective plans that are not optimal.

Thus, in various embodiments the planner component 112 can utilize a quality metric that can allocate a score to each plan in a set of diverse plans and aggregate over the plans in the subject set. Given “n” diverse planners, “P=P₁∪P₂ . . . ∪Pₙ” can represent the set of all plans found by the planners. Further, “π₁, . . . πₖ” can be “k” plans with the lowest cost, ordered by their cost from smallest to largest and “cᵢ=C(πᵢ), wherein “i” can be a subject iteration. For a planner “j”, the quality of the solution for a given iteration Pⱼ can be measured relatively to the best known “k” plan costs (e.g., which can be represented by “c₁, . . . cₖ”). Thus, the quality metric can be defined by the following equation:

$${Q}_{c} := \frac{1}{k} \times {\sum }_{i = 1}^{i = k} \frac{{c}_{i}}{{c}_{i}^{j}}$$

Wherein each sum component of the quality metric can be between 0 and 1, and thus the while score value can be between 0 and 1. Further, a subject solution “Pⱼ” can get the score 1 if it consists of “k” cheapest plans found by the planner component 112.

In various embodiments, the modification component 114 can reformulate a planning task to facilitate generation of a set of diverse plans by the planner component 112. For example, the modification component 114 can perform one or more metric dependent reformulations, wherein a plan that is similar (e.g., in accordance to the given metric) to one or more other plans existing in the subject set of plans can be forbidden from inclusion in the set. For instance, the modification component 114 can perform one or more stability metric dependent reformulations that can ignore orders between actions in a plan and forbid possible re-orderings of a given plan.

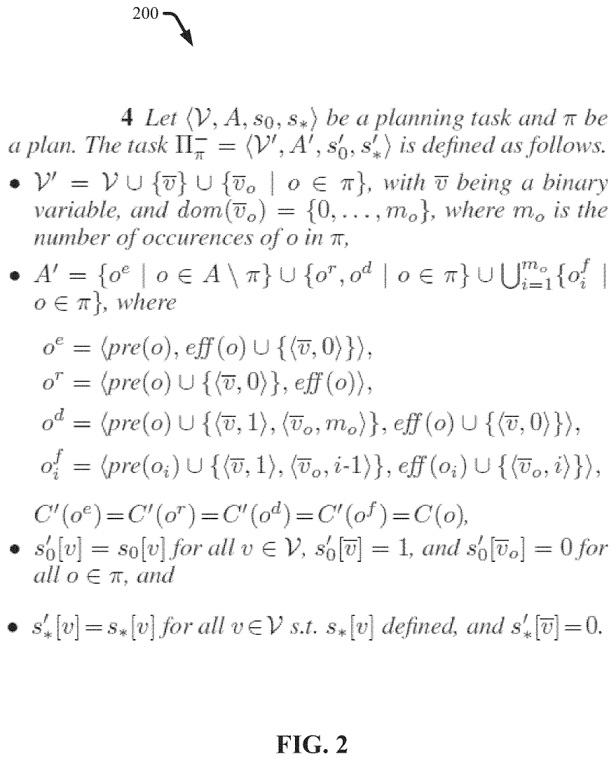

FIG. 2 illustrates a diagram of an example, non-limiting reformulation algorithm 200 that can facilitate the generation of one or more modifications to a planning task by the modification component 114 in accordance with one or more embodiments described herein. Repetitive description of like elements employed in other embodiments described herein is omitted for sake of brevity. One of ordinary skill in the art will recognize that the particular content and/or organizational scheme of the reformulation algorithm 200 exemplary, and variations of the reformulation algorithm 200 that facilitate the features of the modification component 114 described herein are also envisaged.

With regards to the exemplary reformulation algorithm 200, the variable “υ̅” can start from the value 1 and switch to 0 when an action is applied that is not from the plan “π” treated as a multiset. Once a value 0 is reached, indicating a deviation from the plan “π”, the variable cannot be switched by to 1. Variables “υ̅ₒ” can encode the amount of applications of the action “o”. The actions “o^{r}” and/or “o^{d}” can be copies of the action “o” in plan “π” for the cases when the plan “π” can already be discarded from consideration by the modification component 114 (e.g., when variable “υ̅” has been switched its value to 0) and/or can be discarded from consideration by the modification component 114 (e.g., when switching variable “υ̅” to 0). The latter can happen if the action “o” was already applied as many times as it appears in the plan “π”. The actions “oᵢ^{f}” can be copies of the action “o” in the plan “π”, counting the number of applications of “o”, as long as the number is less than the number of times it appears in the plan “π” (e.g., thereby these actions can be applicable so long as the plan is still being followed).

When a set of plans is available (e.g., obtained by the diverse planning component 108 through application of one or more structural symmetries) the modification component 114 can reformulate the plan via a series of modification as defined in the exemplary reformulation algorithm 200. Alternatively, the modification component 114 can forbid possibly more than just that set of plans by exploiting a reformulation algorithm (e.g., exemplary reformulation algorithm 200) for forbidding a multiset of actions that can be a superset of all plans comprised within the set. For example, the modification component 114 can perform each iteration of generating modifications starting from the original planning task and forbidding plans previously found (e.g., forbidding plans that were generated based on previous modification to the planning task). In other words, the modification component 114 can perform multiple iterations of modifications to generate a plurality of diverse planning tasks that can facilitate generation of a plurality of diverse plans by the planner component 112. Further, each iteration performed by the modification component 114 can comprise modifying reformulating the original planning task with a new modification or reformulating a modified planning task with an additional, new modification. Further, each plan generated by the diverse planning component 108 can be a variant of each other such that duplicate plans are not generated during formation of a set of diverse plans.

Thus, in one or more embodiments the diverse planning component 108 can generate one or more sets of diverse plans by modifying a planning task. By modifying the planning task, the diverse planning component 108 can utilize a common AI planner algorithm to generate a plurality of variant plans to achieve a set of diverse plans. Additionally, since a common AI planner algorithm can be utilized to generate the respective plans of the set of diverse plans, the diverse planning component 108 can achieve a variety of diverse planning solutions to meet a variety of different types of diverse planning problems and/or optimization planning problems.

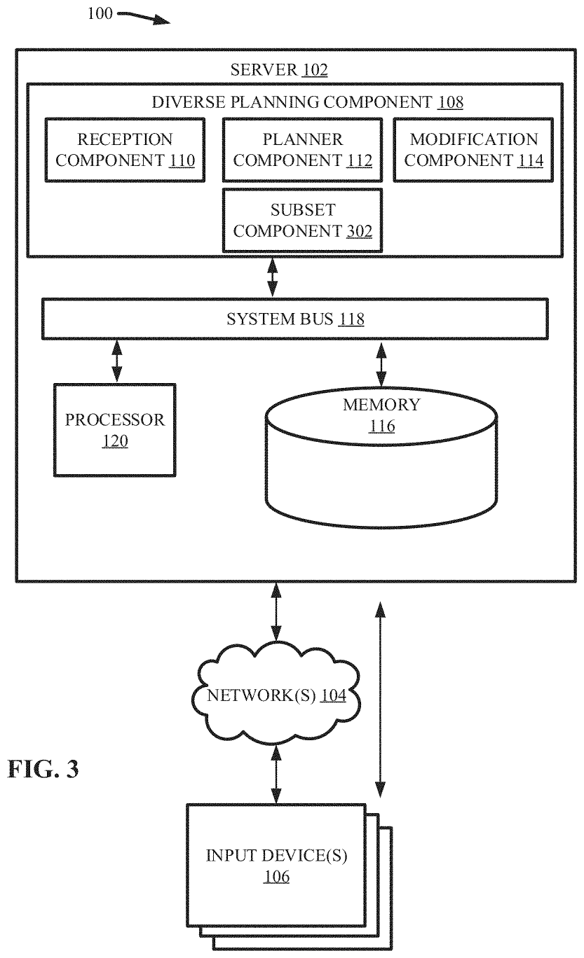

FIG. 3 illustrates a diagram of the example, non-limiting system 100 further comprising a subset component 302 that can facilitate post-processing of one or more sets of diverse plans generated by the diverse planning component 108 in accordance with one or more embodiments described herein. Repetitive description of like elements employed in other embodiments described herein is omitted for sake of brevity.

In one or more embodiments, the diverse planning component 108 can further comprise a subset component 302, which can filter and/or cluster one or more sets of diverse plans to generate one or more subsets of diverse plans. For example, the subset component 302 can generate a plurality of clusters from a set of diverse plans based on one or more quality metrics and/or diversity metrics. For instance, in one or more embodiments the subset component 302 can order the plans of a subject set of diverse plans by their respective costs. Then, starting with the cheapest plans, the subset component 302 can find one or more pairs of plans with the largest diversity score. Starting with the pair of plans, the subset component 302 can iteratively construct the set of diverse plans by choosing the next plan to add to the set and maximizing the diversity of the resulting set at that iteration step. The iterations of the subset component 302 can cease once the subject set of diverse plans reaches the defined size “k” (e.g., which can be defined by a user of the system 100 using the one or more input devices 106 and/or the one or more networks 104). One of ordinary skill in the art will recognize that alternative clustering approaches can also be utilized by the subset component 302 to generate one or more subsets of diverse plans in accordance with one or more user-defined preferences (e.g., such as the user-preferred size of the subset).

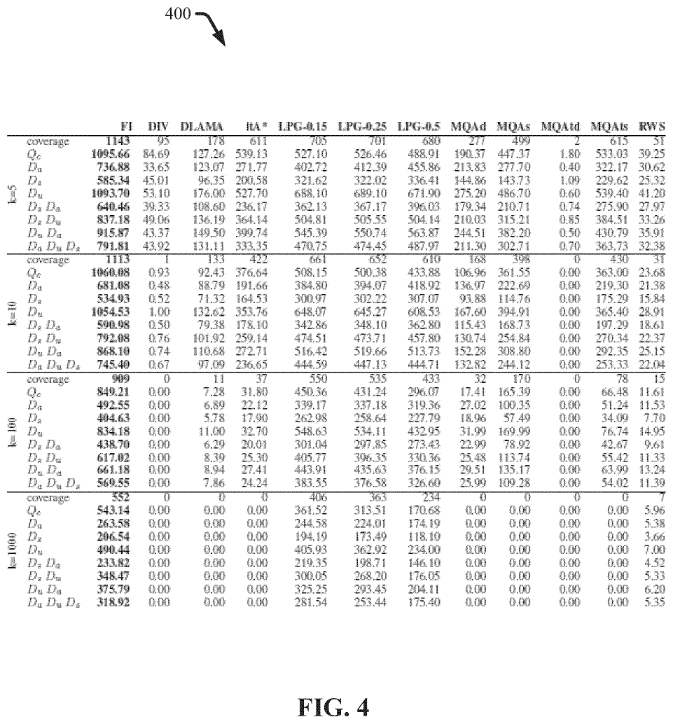

FIG. 4 illustrates a diagram of an example, non-limiting table 400 that can utilize to evaluate the efficacy of the system 100 and various features thereof according to existing metrics in accordance with one or more embodiments described herein. Repetitive description of like elements employed in other embodiments described herein is omitted for sake of brevity. For example, table 400 can depict a comparison of the various embodiments described herein with conventional satisficing diverse planners including, for example: LPG-D (e.g., with three variants, varying the diversity parameter “d” to obtain values 0.15, 0.25, and/or 0.5), DLAMA, DIV, itA*, RWS, MQAd, MQAs, MQAtd, and/or MQAts. As shown in FIG. 4, “Dₐ” can represent the stability diversity metric, “Dₛ” can represent the state diversity metric, and/or “Dᵤ” can represent the uniqueness diversity metric. Further, multiple diversity metrics in a row can represent a linear combination thereof. Also, “Q_{c}” can represent the cost quality metric.

As shown in FIG. 4, the comparison depicted in table 400 was conducted with various values of “k”, the number of required plans, including: 5, 10, 100, and/or 1000. To compare to all chosen conventional planners, the benchmark set can be restricted to STRIPS (e.g., a known collection of planning domains) domains with uniform action costs from International Planning Competitions (“IPC”); thereby resulting in 1306 planning tasks in 41 domains. The experiments were performed on Intel® Xeon® CPU E7-8837 @2.67 GHz machines, with the time and memory limit of 30 minutes and 2 GB, respectively. As shown in table 400, “FI” can represent the one or more of the various embodiments described herein. The one or more various embodiments described herein can iteratively solve a planning task, find a set of solutions, and/or create one or more new planning tasks that forbid a superset of the solutions found so far. Considering plans as multisets (e.g., ignoring the order between actions), the superset can be defined as the union of all plans found so far. Thus, the one or more divers planning approaches described herein can forbid reordering of found plans (e.g., and optionally additional solutions) corresponding to a union of multiple found solutions. For example, wherein the size of found solutions is restricted to 1000, if the desired number of solutions is lower, then the various embodiments described herein (e.g., the diverse planning component 108) can choose a subset according to one or more given diversity metrics; which can result in different subsets of diverse plans chosen for different metrics.

For solving the planning tasks (e.g., the original planning task and/or one or more reformulated planning tasks), the “FI” approach (e.g., via the diverse planning component 108) can use an existing state-of-the-art agile planner (e.g., which can comprise the planner component 112). The planner chosen with regards to the data present in table 400 was MERWIN; which can perform a greedy best-first search (“GBFS”), alternating between four queues (e.g., novelty of the red-black heuristic, landmark count, preferred operators from the red-black heuristic, and/or preferred operators from the landmark count heuristic).

Each technique can get a score for each task and each metric between 0 and 1. If not enough unique plans are found by some planner on a planning task, the planner can get a score of 0 for that subject planning task. Table 400 can depict the summed scores for all the tested planners on all the tested metrics. As shown in FIG. 4, the diverse planning approach described with regards to the various embodiments herein (e.g., represented by “FI”) can excel on all metrics (e.g., including both diversity and quality), which can be at least partially contributed to an increased coverage (e.g., by 62% for “k=5”, 68% for “k=10”, 65% for “k=100”, and/or 36% for “k=1000”). Additionally, the diverse planning approach described with regards to the various embodiments herein (e.g., represented by “FI”), shows improvement over the conventional diverse planning approaches with regards to the quality metrics (e.g., showing an improvement by over 100% for the smaller values of “k” equaling 5 and/or 10, by 88% for “k=100, and/or by 50% for “k=1000”). Further various diversity metrics, the improvement demonstrated by the one or more embodiments described herein can be between 59% and 74% for “k=5” and “k=10”, between 45% and 54% for “k=100”, and/or 6% and 21% for “k=1000.”

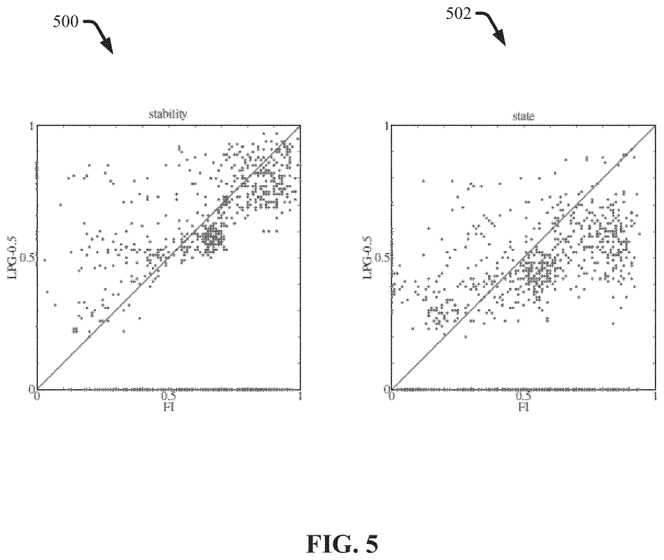

FIG. 5 illustrates a diagram of example, non-limiting graphs 500 and 502 to further depict the efficacy of the one or more diverse planning approaches that can be autonomously implemented by the system 100 in accordance with one or more embodiments described herein. Repetitive description of like elements employed in other embodiments described herein is omitted for sake of brevity. Graph 500 can depict a comparison of the diverse planning approach of the various embodiments described herein and the LPG planner with a stability diversity metric of 0.5 for a “k” value of 5. Graph 502 depict a comparison of the one or more diverse planning approaches of the various embodiments described herein and the LPG planner with a state diversity metric of 0.5 for a “k” value of 5.

Graphs 500 and 502 can show two diversity metrics (e.g., stability diversity metric and/or state diversity metric), wherein each planning task can correspond to a single point and graphical coordinates representing the metric value. The points above the respective diagonal lines of graph 500 and/or graph 502 can be in favor of LPG, while the points below the diagonal lines can favor the one or more diverse planning approaches of the various embodiments described herein. Points on the axes of graph 500 and/or graph 502 can represent planning tasks that were either solved by one technique but not the other or a score of 0 obtained by one of the techniques.

Regarding the stability diversity metric depicted by graph 500, there are 884 planning tasks located below the diagonal line and 490 of these planning tasks are on the x-axis. Further, there are 286 planning tasks above the diagonal line and 41 of these planning tasks are on the y-axis. Regarding the state diversity metric depicted by graph 502, there are 938 planning tasks below the diagonal line and 495 of these planning tasks are on the x-axis. Further, there are 237 planning tasks above the diagonal line and 39 of these planning tasks are on the y-axis.

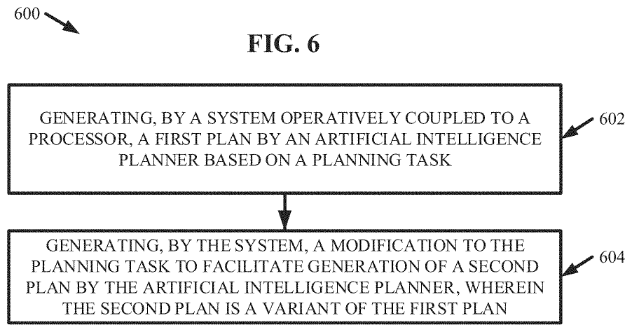

FIG. 6 illustrates a flow diagram of an example, non-limiting method 600 that can facilitate generating one or more sets of diverse plans in accordance with one or more embodiments described herein. Repetitive description of like elements employed in other embodiments described herein is omitted for sake of brevity.

At 602, the method 600 can comprise generating, by a system 100 operatively coupled to a processor 120, a first plan by an AI planner (e.g., planner component 112) based on one or more planning tasks. The one or more first plans and/or planning tasks generated at 602 (e.g., via the planner component 112) can comprise one or more diverse planning solutions (e.g., a satisficing diverse planning solution, a diversity-bounded diverse planning solution, a quality-bounded diverse planning solution, a bounded quality and diversity diverse planning solution, an optimal quality diverse planning solution, an optimal diversity diverse planning solution, an optimal quality bounded diversity diverse planning solution, an optimal diversity bounded quality diverse planning solution, and/or a pareto-optimal diverse planning solution) to one or more diverse planning problems (e.g., as described with regards to various embodiments herein).

At 604, the method 600 can comprise generating, by the system 100 (e.g., via the modification component 114), a modification to the planning task of 602 to facilitate generation of a second plan by the AI planner (e.g., planner component 112), wherein the second plan can be a variant of the first plan. In one or more embodiments, the generating (e.g., via the modification component 114) the one or more modifications at 604 can comprise reformulating the planning task of the first plan. In various embodiments, the generation at 604 can comprise reformulating a modified planning task (e.g., a planning task that was generated by a first modification to an original planning task) to generate the second plan.

In various embodiments, the features of method 600 can be repeated (e.g., via the diverse planning component 108) through multiple iterations to generate a plurality of diverse plans that can be comprised with a set. For example, the method 600 can comprise generating (e.g., via the diverse planning component 108) a plurality of diverse plans (e.g., each of which can be variants of each other) based on a plurality of modifications to one or more planning tasks.

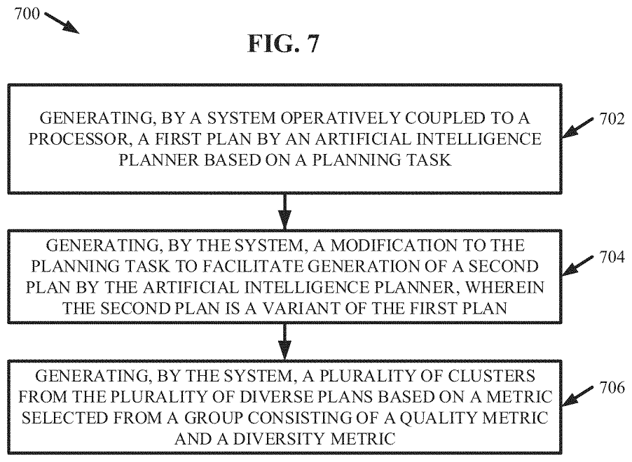

FIG. 7 illustrates a flow diagram of an example, non-limiting method 700 that can facilitate generating one or more sets of diverse plans in accordance with one or more embodiments described herein. Repetitive description of like elements employed in other embodiments described herein is omitted for sake of brevity.

At 702, the method 700 can comprise generating, by a system 100 operatively coupled to a processor 120, a first plan by an AI planner (e.g., planner component 112) based on one or more planning tasks. The one or more first plans and/or planning tasks generated at 702 (e.g., via the planner component 112) can comprise one or more diverse planning solutions (e.g., a satisficing diverse planning solution, a diversity-bounded diverse planning solution, a quality-bounded diverse planning solution, a bounded quality and diversity diverse planning solution, an optimal quality diverse planning solution, an optimal diversity diverse planning solution, an optimal quality bounded diversity diverse planning solution, an optimal diversity bounded quality diverse planning solution, and/or a pareto-optimal diverse planning solution) to one or more diverse planning problems (e.g., as described with regards to various embodiments herein).

At 704, the method 700 can comprise generating, by the system 100 (e.g., via the modification component 114), a modification to the planning task of 702 to facilitate generation of a second plan by the AI planner (e.g., planner component 112), wherein the second plan can be a variant of the first plan. In one or more embodiments, the generating (e.g., via the modification component 114) the one or more modifications at 704 can comprise reformulating the planning task of the first plan. In various embodiments, the generation at 704 can comprise reformulating a modified planning task (e.g., a planning task that was generated by a first modification to an original planning task) to generate the second plan.

At 706, the method 700 can further comprise generating, by the system 100 (e.g., via the subset component 302), a plurality of clusters from the plurality of diverse plans based on a metric selected from a group consisting of one or more quality metrics and/or one or more diversity metrics. For example, the one or more quality metrics and/or the one or more diversity metrics can be one or more variables and/or characteristics of the one or more plans in accordance with the various embodiments described herein. For instance, the clustering at 706 can be based on one or more quality metrics where quality of a plan can be measured (e.g., by the subset component 302) by the cost of the plan. In another instance, the clustering at 706 can be based on a combination of respective diversity metrics (e.g., a linear combination of a plurality of diversity metrics).

In various embodiments, the features of method 600 can be repeated (e.g., via the diverse planning component 108) through multiple iterations to generate a plurality of diverse plans that can be comprised with a set. For example, the method 600 can comprise generating (e.g., via the diverse planning component 108) a plurality of diverse plans (e.g., each of which can be variants of each other) based on a plurality of modifications to one or more planning tasks.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

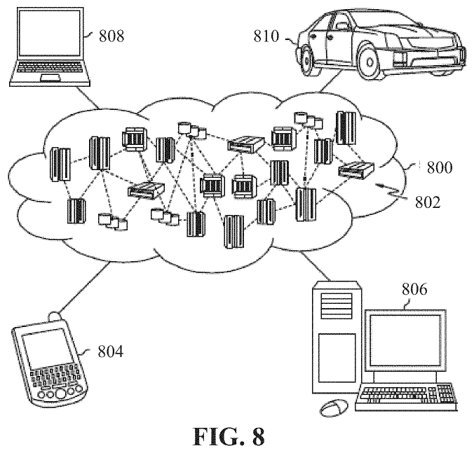

Referring now to FIG. 8, illustrative cloud computing environment 800 is depicted. As shown, cloud computing environment 800 includes one or more cloud computing nodes 802 with which local computing devices used by cloud consumers, such as, for example, personal digital assistant (PDA) or cellular telephone 804, desktop computer 806, laptop computer 808, and/or automobile computer system 810 may communicate. Nodes 802 may communicate with one another. They may be grouped (not shown) physically or virtually, in one or more networks, such as Private, Community, Public, or Hybrid clouds as described hereinabove, or a combination thereof. This allows cloud computing environment 800 to offer infrastructure, platforms and/or software as services for which a cloud consumer does not need to maintain resources on a local computing device. It is understood that the types of computing devices 804-810 shown in FIG. 8 are intended to be illustrative only and that computing nodes 802 and cloud computing environment 800 can communicate with any type of computerized device over any type of network and/or network addressable connection (e.g., using a web browser).

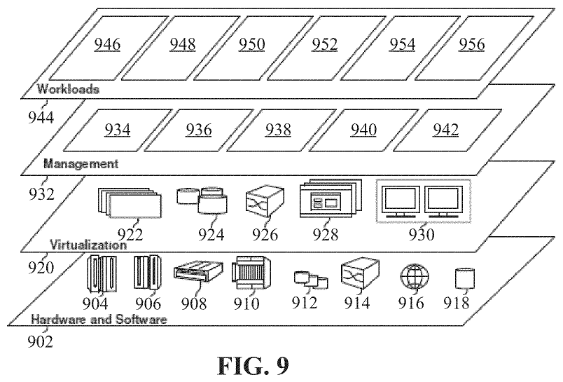

Referring now to FIG. 9, a set of functional abstraction layers provided by cloud computing environment 800 (FIG. 8) is shown. Repetitive description of like elements employed in other embodiments described herein is omitted for sake of brevity. It should be understood in advance that the components, layers, and functions shown in FIG. 9 are intended to be illustrative only and embodiments of the invention are not limited thereto. As depicted, the following layers and corresponding functions are provided.

Hardware and software layer 902 includes hardware and software components. Examples of hardware components include: mainframes 904; RISC (Reduced Instruction Set Computer) architecture based servers 906; servers 908; blade servers 910; storage devices 912; and networks and networking components 914. In some embodiments, software components include network application server software 916 and database software 918.

Virtualization layer 920 provides an abstraction layer from which the following examples of virtual entities may be provided: virtual servers 922; virtual storage 924; virtual networks 926, including virtual private networks; virtual applications and operating systems 928; and virtual clients 930.

In one example, management layer 932 may provide the functions described below. Resource provisioning 934 provides dynamic procurement of computing resources and other resources that are utilized to perform tasks within the cloud computing environment. Metering and Pricing 936 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 938 provides access to the cloud computing environment for consumers and system administrators. Service level management 940 provides cloud computing resource allocation and management such that required service levels are met. Service Level Agreement (SLA) planning and fulfillment 942 provide pre-arrangement for, and procurement of, cloud computing resources for which a future requirement is anticipated in accordance with an SLA.

Workloads layer 944 provides examples of functionality for which the cloud computing environment may be utilized. Examples of workloads and functions which may be provided from this layer include: mapping and navigation 946; software development and lifecycle management 948; virtual classroom education delivery 950; data analytics processing 952; transaction processing 954; and diverse planning 956. Various embodiments of the present invention can utilize the cloud computing environment described with reference to FIGS. 8 and 9 to autonomously generate one or more sets of diverse plans in accordance with one or more embodiments described herein.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

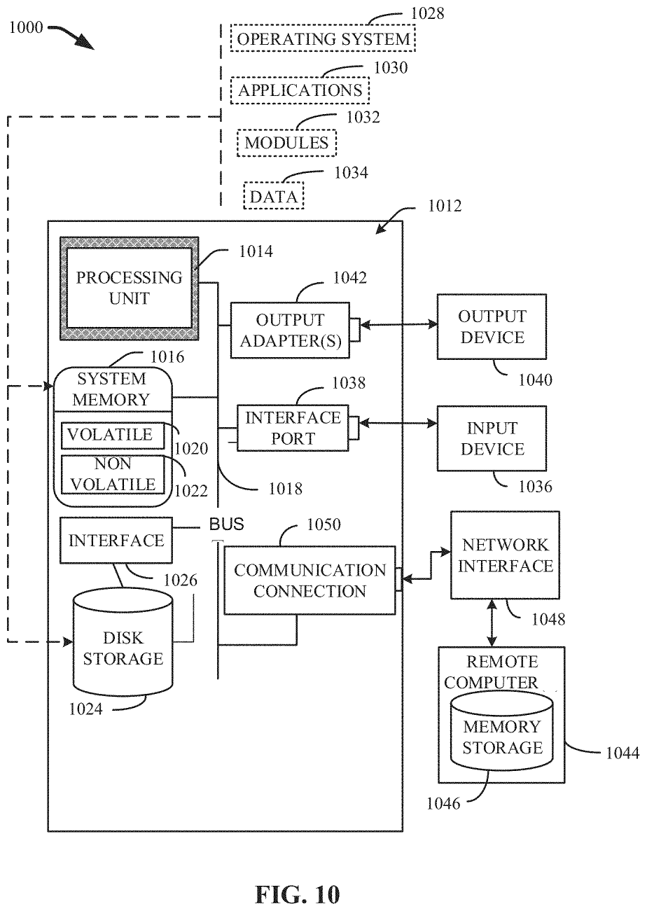

In order to provide a context for the various aspects of the disclosed subject matter, FIG. 10 as well as the following discussion are intended to provide a general description of a suitable environment in which the various aspects of the disclosed subject matter can be implemented. FIG. 10 illustrates a block diagram of an example, non-limiting operating environment in which one or more embodiments described herein can be facilitated. Repetitive description of like elements employed in other embodiments described herein is omitted for sake of brevity. With reference to FIG. 10, a suitable operating environment 1000 for implementing various aspects of this disclosure can include a computer 1012. The computer 1012 can also include a processing unit 1014, a system memory 1016, and a system bus 1018. The system bus 1018 can operably couple system components including, but not limited to, the system memory 1016 to the processing unit 1014. The processing unit 1014 can be any of various available processors. Dual microprocessors and other multiprocessor architectures also can be employed as the processing unit 1014. The system bus 1018 can be any of several types of bus structures including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire, and Small Computer Systems Interface (SCSI). The system memory 1016 can also include volatile memory 1020 and nonvolatile memory 1022. The basic input/output system (BIOS), containing the basic routines to transfer information between elements within the computer 1012, such as during start-up, can be stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1020 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1012 can also include removable/non-removable, volatile/non-volatile computer storage media. FIG. 10 illustrates, for example, a disk storage 1024. Disk storage 1024 can also include, but is not limited to, devices like a magnetic disk drive, floppy disk drive, tape drive, Jaz drive, Zip drive, LS-100 drive, flash memory card, or memory stick. The disk storage 1024 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1024 to the system bus 1018, a removable or non-removable interface can be used, such as interface 1026. FIG. 10 also depicts software that can act as an intermediary between users and the basic computer resources described in the suitable operating environment 1000. Such software can also include, for example, an operating system 1028. Operating system 1028, which can be stored on disk storage 1024, acts to control and allocate resources of the computer 1012. System applications 1030 can take advantage of the management of resources by operating system 1028 through program modules 1032 and program data 1034, e.g., stored either in system memory 1016 or on disk storage 1024. It is to be appreciated that this disclosure can be implemented with various operating systems or combinations of operating systems. A user enters commands or information into the computer 1012 through one or more input devices 1036. Input devices 1036 can include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices can connect to the processing unit 1014 through the system bus 1018 via one or more interface ports 1038. The one or more Interface ports 1038 can include, for example, a serial port, a parallel port, a game port, and a universal serial bus (USB). One or more output devices 1040 can use some of the same type of ports as input device 1036. Thus, for example, a USB port can be used to provide input to computer 1012, and to output information from computer 1012 to an output device 1040. Output adapter 1042 can be provided to illustrate that there are some output devices 1040 like monitors, speakers, and printers, among other output devices 1040, which require special adapters. The output adapters 1042 can include, by way of illustration and not limitation, video and sound cards that provide a means of connection between the output device 1040 and the system bus 1018. It should be noted that other devices and/or systems of devices provide both input and output capabilities such as one or more remote computers 1044.

Computer 1012 can operate in a networked environment using logical connections to one or more remote computers, such as remote computer 1044. The remote computer 1044 can be a computer, a server, a router, a network PC, a workstation, a microprocessor based appliance, a peer device or other common network node and the like, and typically can also include many or all of the elements described relative to computer 1012. For purposes of brevity, only a memory storage device 1046 is illustrated with remote computer 1044. Remote computer 1044 can be logically connected to computer 1012 through a network interface 1048 and then physically connected via communication connection 1050. Further, operation can be distributed across multiple (local and remote) systems. Network interface 1048 can encompass wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). One or more communication connections 1050 refers to the hardware/software employed to connect the network interface 1048 to the system bus 1018. While communication connection 1050 is shown for illustrative clarity inside computer 1012, it can also be external to computer 1012. The hardware/software for connection to the network interface 1048 can also include, for exemplary purposes only, internal and external technologies such as, modems including regular telephone grade modems, cable modems and DSL modems, ISDN adapters, and Ethernet cards.

Embodiments of the present invention can be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various aspects of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to customize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which includes one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device including, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components including a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components;
a processor, operably coupled to the memory, and that executes the computer executable components stored in the memory, wherein the computer executable components comprise:
a planner component, operably coupled to the processor, that generates a first plan based on a planning task; and
a modification component, operably coupled to the processor, that generates a modification to the planning task to facilitate generation of a second plan by the planner component, wherein the second plan is a variant of the first plan.

2. The system of claim 1, wherein the modification is comprised within a plurality of modifications to the planning task generated by the modification component, and wherein the second plan is comprised within a plurality of diverse plans generated by the planner component.

3. The system of claim 2, wherein respective plans of the plurality of diverse plans are generated based on respective modifications of the plurality of modifications.

4. The system of claim 3, further comprising:
a subset component, operably coupled to the processor, that generates a plurality of clusters from the plurality of diverse plans based on a metric selected from a group consisting of a quality metric and a diversity metric.

5. The system of claim 3, further comprising:
a reception component, operably coupled to the processor, that receives an integer value, wherein a number of plans comprising the plurality of diverse plans is greater than or equal to the integer value.

6. The system of claim 1, wherein the modification component further generates a second modification to the planning task, wherein the planner component generates the second plan based on the modification and a third plan based on the second modification, and wherein the third plan is another variant of both the first plan and the second plan.

7. The system of claim 1, wherein the modification to the planning task forms a second planning task to facilitate generation of the second plan by the planner component, wherein the modification component further generates a subsequent modification to the second planning task to form a third planning task, and wherein the third planning task is different than the planning task.

8. The system of claim 1, wherein the modification is different than previous modifications to the planning task generated by the modification component.

9. The system of claim 1, wherein the modification component generates the modification in a cloud computing environment.

10. A computer-implemented method, comprising:
generating, by a system operatively coupled to a processor, a first plan by an artificial intelligence planner based on a planning task; and
generating, by the system, a modification to the planning task to facilitate generation of a second plan by the artificial intelligence planner, wherein the second plan is a variant of the first plan.

11. The computer-implemented method of claim 10, further comprising:
generating, by the system, a plurality of modifications to the planning task to facilitate generation of a plurality of diverse plans, wherein respective plans of the plurality of diverse plans are generated based on respective modifications of the plurality of modifications.

12. The computer-implemented method of claim 11, further comprising:
generating, by the system, a plurality of clusters from the plurality of diverse plans based on a metric selected from a group consisting of a quality metric and a diversity metric.

13. The computer-implemented method of claim 10, wherein the modification is different than previous modifications to the planning task generated by the system.

14. The computer-implemented method of claim 10, further comprising:
forming, by the system, a second planning task based on the modification;
generating, by the system, a second modification that modifies the planning task; and
generating, by the system, a third plan by the artificial intelligence planner based on the planning task modified by the second modification, wherein the third plan is another variant of both the first plan and the second plan.

15. The computer-implemented method of claim 10, further comprising:
forming, by the system, a second planning task based on the modification;
generating, by the system, a second modification that modifies the second planning task; and
generating, by the system, a third plan by the artificial intelligence planner based on the second planning task modified by the second modification, wherein the third plan is another variant of both the first plan and the second plan.

16. A computer program product for generating a set of diverse plans, the computer program product comprising a computer readable storage medium having program instructions embodied therewith, the program instructions executable by a processor to cause the processor to:
generate, by a system operatively coupled to the processor, a first plan by an artificial intelligence planner based on a planning task; and
generate, by the system, a modification to the planning task to facilitate generation of a second plan by the artificial intelligence planner, wherein the second plan is a variant of the first plan.

17. The computer program product of claim 16, wherein the program instructions further cause the processor to:
generate, by the system, a plurality of modifications to the planning task to facilitate generation of a plurality of diverse plans, wherein respective plans of the plurality of diverse plans are generated based on respective modifications of the plurality of modifications.

18. The computer program product of claim 17, wherein the program instructions further cause the processor to:
generate, by the system, a plurality of clusters from the plurality of diverse plans based on a metric selected from a group consisting of a quality metric and a diversity metric.

19. The computer program product of claim 16, wherein the modification is different than previous modifications to the planning task generated by the system.

20. The computer program product of claim 16, wherein the modification is generated in a cloud computing environment.
